(19) United States
(12) Patent Application Publication
(10) Pub. No.: US 2014/0312545 A1
(43) Pub. Date: Oct. 23, 2014

(54) SPRING ISOLATOR

(71) Applicant: ZF FRIEDRICHSHAFEN AG, Friedrichshafen (DE)

(72) Inventor: Raise Ahmed, Novi, MI (US)

(21) Appl. No.: 13/868,565

(22) Filed: Apr. 23, 2013

(51) Int. Cl. B60G 11/22; F16F 1/36

(52) U.S. Cl. CPC B60G 11/22; F16F 1/36; F16F 1/3605; B60G 2202/14; B60G 2206/81012
USPC 267/292; 264/259; 264/138

(57) ABSTRACT

A spring isolator may include a first portion and second portion joined together or integrally formed and configured to dampen and absorb loads from a coil spring. The first portion may be a microcellular polyurethane material and the second portion may be a thermoplastic polyurethane material. The first portion and second portion may be chemically bonded together along at least one boundary by injection molding the second portion into a mold already containing the first portion. The spring isolator made from chemically bonded portions may provide effective resistance to radial and longitudinal migration of the isolator upon introduction of coil spring forces and vibration.

### BACKGROUND OF THE INVENTION

A vehicle's suspension system connects a vehicle to its wheels and allows relative motion between them. The suspension system serves multiple purposes—contributing to a vehicle's handling and braking ability, and isolating the vehicle, its occupants, and its contents from bumps, vibrations, and noise. A vehicle's suspension may include coil springs that compress and expand to support the weight of the vehicle and absorb motion between the wheels and the vehicle. The coil spring may be attached to the vehicle through a spring seat. The spring seat may include an isolator situated between the coil spring and the vehicle. The isolator may serve to dampen and absorb vibrations of the coil spring.

Due to persistent forces such as weight of the vehicle, input forces transmitted through the spring due to the relative motion of the wheel, and vibrations of the spring, an isolator may wear out over time or may migrate away from its intended position between the end of the spring and the rest of the vehicle causing the spring to directly contact rigid portions of the vehicle. Vibrations of the spring and relative movement between the spring and the rigid portions of the vehicle may lead to increased wear on the contacted vehicle portions, decreased performance and safety, and unsatisfactory noise and ride comfort. Thus, there is a need for a cost-effective spring isolator that may resist wear and migration.

### SUMMARY OF THE INVENTION

The descriptions below include apparatuses for isolating a spring and methods of making such apparatuses. A spring isolator may include a first portion and second portion joined together or integrally formed and configured to dampen and absorb loads from a coil spring. The first portion may be a microcellular polyurethane material and the second portion may be a thermoplastic polyurethane material. The first portion and second portion may be chemically bonded together along at least one boundary by injection molding the second portion into a mold already containing the first portion. The spring isolator made from chemically bonded portions may provide effective resistance to radial and longitudinal migration of the isolator upon introduction of coil spring forces and vibration.

According to one embodiment of the invention, a spring isolator comprises a first portion disposed about a longitudinal axis and forming a contact surface for a spring; a second portion adjacent to the first portion along at least one boundary and disposed about the axis and defining an opening along the axis; wherein the first portion and second portion are chemically bonded together along the at least one boundary.

According to another embodiment of the invention, a method for making a spring isolator comprises a method of making a spring isolator comprising: forming a first portion by cutting a segment from tube-shaped stock; inserting the first portion into an injection mold; injecting thermoplastic polymer material into the injection mold to create a second portion that is chemically bonded to the first portion without the use of any adhesive or external bonding agent; removing the integrally molded spring isolator from the mold; and finishing the spring isolator.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The embodiments described below may be more fully understood by reading the following description in conjunction with the drawings, in which

FIG. 1 is a cross-sectional drawing of a vehicle spring mount assembly including a spring isolator according to one embodiment of the invention;

FIG. 2 is a perspective drawing of a spring isolator according to one embodiment of the invention;

FIG. 3 is a cross-sectional drawing of a spring isolator according to one embodiment of the invention;

FIG. 4 is a cross-sectional drawing of a portion of a spring isolator according to one embodiment of the invention;

FIG. 5 is a cross-sectional drawing of a portion of a spring isolator according to one embodiment of the invention;

FIG. 6 is a cross-sectional drawing of a portion of a spring isolator according to one embodiment of the invention;

FIG. 7 is a cross-sectional drawing of a portion of a spring isolator according to one embodiment of the invention;

FIG. 8 is a cross-sectional drawing of a portion of a spring isolator according to one embodiment of the invention;

FIG. 9 is a flowchart of a method of making a spring isolator according to one embodiment of the invention.

### DETAILED DESCRIPTION

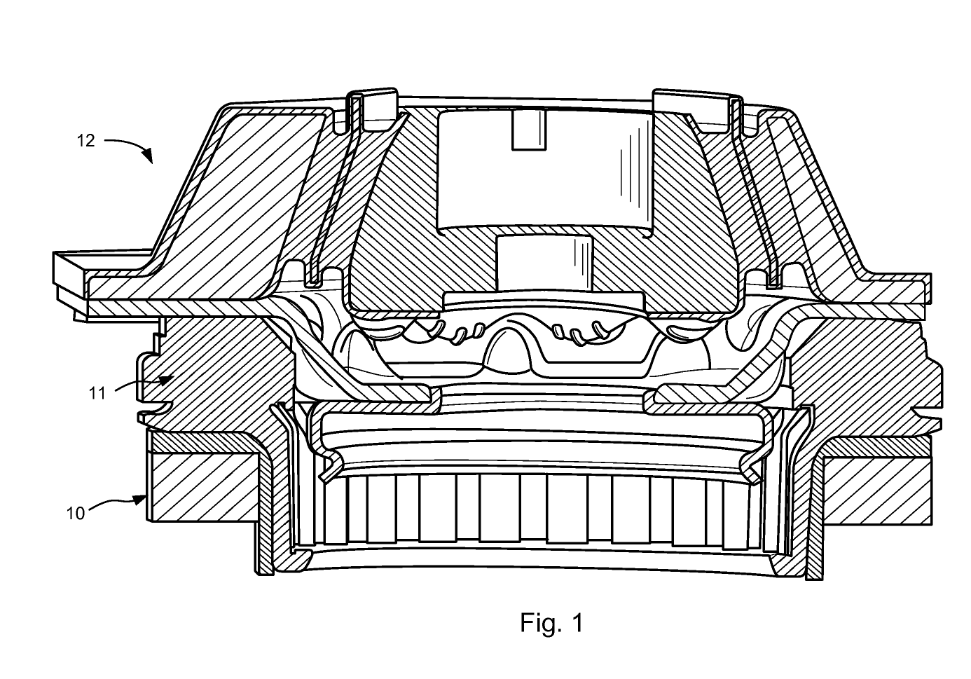

FIG. 1 illustrates how a spring isolator 10 may be installed in a vehicle. Spring isolator 10 is attached to a top mount assembly 12. Spring isolator 10 may be mounted on a bearing housing 11, which is a component of top mount assembly 12. Spring isolator 10 may protect the bearing housing 11 and may isolate the vehicle from the motion and vibrations of a coil spring 50, which is not depicted in FIG. 1.

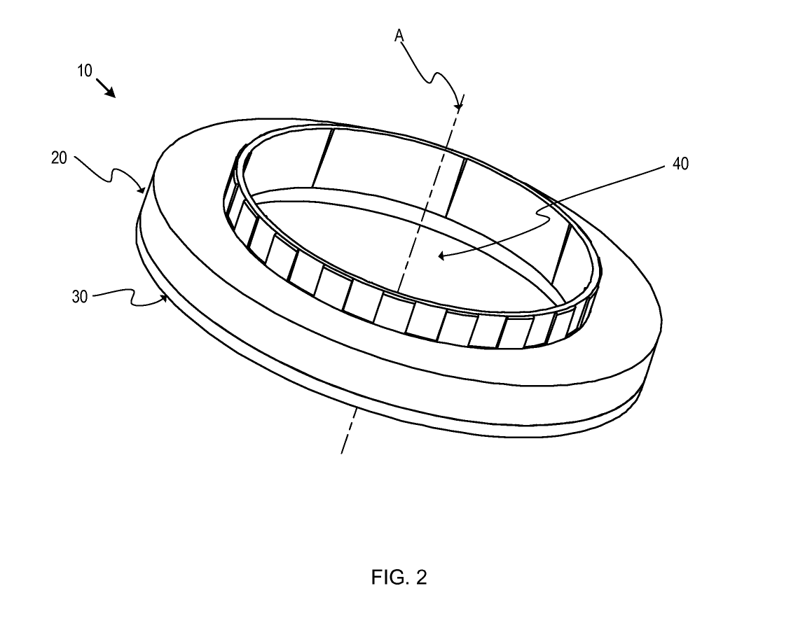

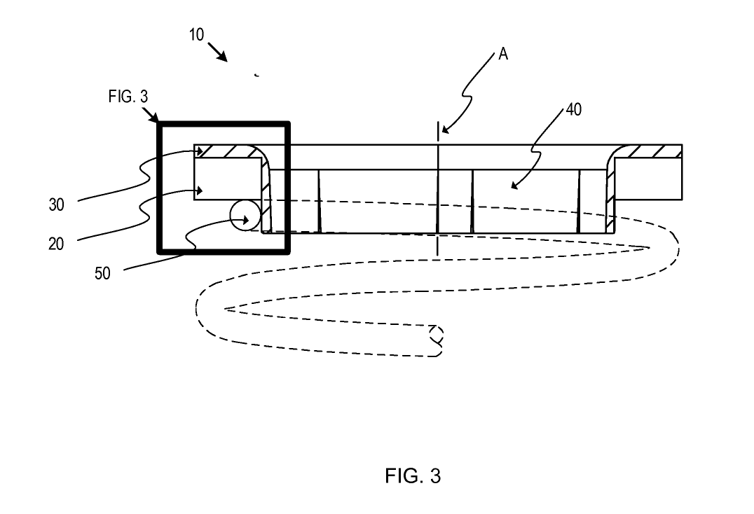

FIGS. 2 and 3 depict the spring isolator 10 in perspective and cross-section respectively. Spring isolator 10 may be made of two portions, a first portion 20 and a second portion 30. First and second portions may be disposed about a longitudinal axis A and may form an opening 40 that extends along the axis A. First portion 20 and second portion 30 may be joined together or integrally formed. For example, first portion 20 and second portion 30 may be chemically bonded together. The end of a coil spring 50 may abut spring isolator 10 at a contact surface of the first portion 20. Spring isolator dampens and absorbs loads and vibrations from coil spring 50.

First portion 20 may be made from a resilient material, such as a polymer or rubber. For example, first portion 20 may be made from microcellular polyurethane (“MCU”). Second portion 30 may be made from polymer, such as thermoplastic polyethylene (“TPE”) or thermoplastic polyurethane (“TPU”), or metal, such as steel. For example, second portion 30 may be made from glass fiber-reinforced TPU.

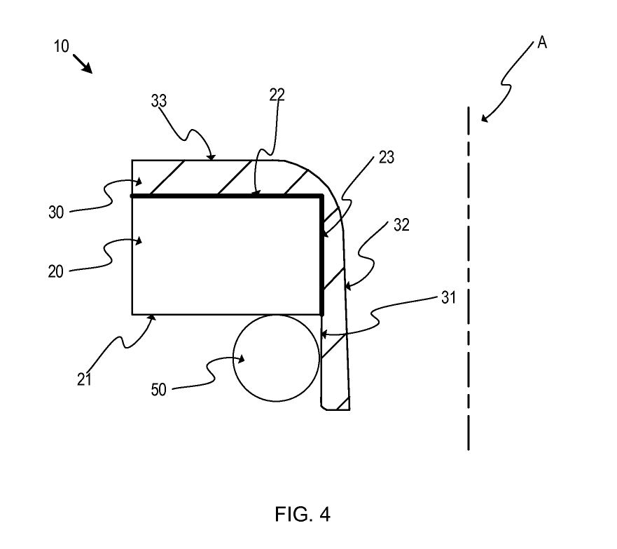

FIG. 4 depicts a cross-sectional view of a section of spring isolator 10. First portion 20 may have a generally rectangular cross-section with a thickness measured along the axis A between a contact surface 21, and a distal boundary 22. Other cross-sectional shapes are possible, for example, square, trapezoidal, and elliptical. First portion 20 may also have an inner boundary 23 defining the nearest surface of first portion 20 to axis A. First portion 20 may be adjoined with second portion 30 along two boundaries, distal boundary 22 and inner boundary 23, indicated by a thicker line in FIG. 4.

Second portion 30 may have a generally “L-shaped” cross-section with inner surface 32 defining opening 40 which extends along axis A. Second portion 30 also may have a distal section 33 that abuts the mount assembly 11. Second portion 30 may also have a spring retention section 31 that extends longitudinally along axis A beyond the first portion 20 that may maintain the position of the coil spring 50 in a radial direction.

Spring isolator 10 may absorb and dampen longitudinal forces and vibrations through the resilient and compressible first portion 20 while first portion 20 is fully supported and prevented from radial and longitudinal migration by adjoinment to second portion 30. Spring isolator 10 is particularly advantageous when second portion 30 is a TPU material injection molded in the presence of first portion 20 made from MCU. The chemical bond without the use of any adhesive or external bonding agent resulting between first portion 20 and second portion 30 in the integrally molded spring isolator 10 prevents migration of the first portion 20 especially effectively.

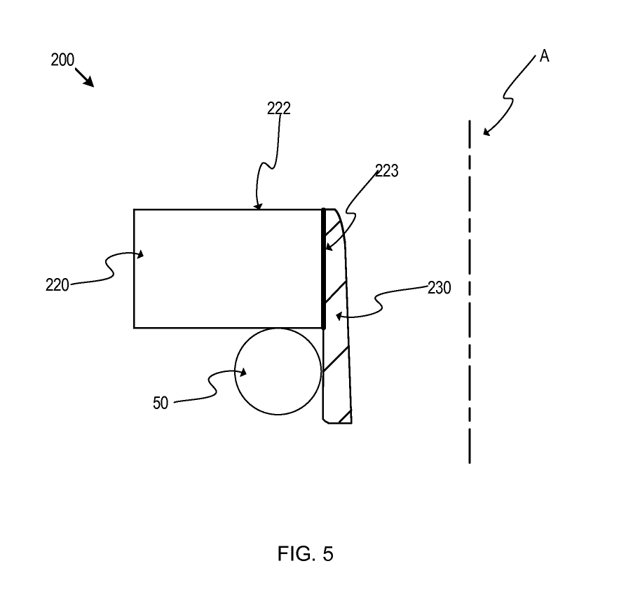

FIG. 5 depicts a cross-sectional view of a section of spring isolator 200 where first portion 220 may be bonded to second portion 230 along one boundary, inner boundary 223, indicated by a thicker line in FIG. 5. Second portion 230 may not have a longitudinal section distal to first portion 220. Therefore, first portion 220 may have a distal surface 222 that abuts the mount assembly 11. The bond along inner boundary 223 may advantageously provide support to, and prevent migration of, first portion 220.

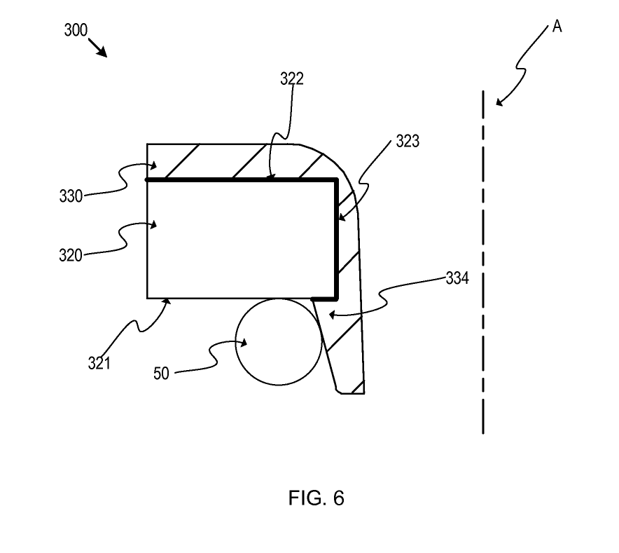

FIG. 6 depicts a cross-sectional view of a section of spring isolator 300 where first portion 320 and second portion 330 may be bonded along three boundaries, including inner boundary 323 and distal boundary 322. Second portion 330 may have rim 334 extending radially away from axis A over a portion of contact surface 321 of first portion 320, thereby creating a third boundary along which first portion 320 and second portion 330 are bonded. The three bonding boundaries are indicated in by a thicker line in FIG. 6. Rim 334 and an additional bonding boundary on contact surface 321 may additionally or alternatively prevent migration, particularly in a longitudinal direction.

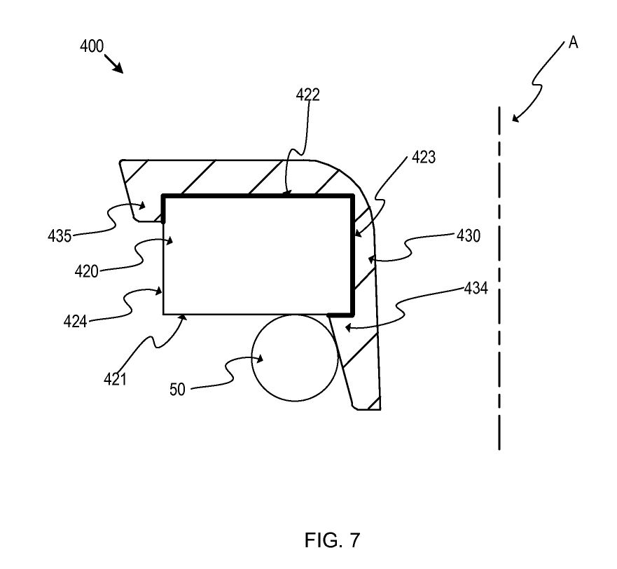

FIG. 7 depicts a cross-sectional view of a section of spring isolator 400 where first portion 420 and second portion 430 may be bonded along four boundaries, including inner boundary 423 and distal boundary 422. Second portion 430 may have a longitudinal rim 434 extending radially away from axis A over a portion of contact surface 421 of first portion 420, thereby creating a third boundary along which first portion 420 and second portion 430 are bonded. Second portion 430 may alternatively or additionally have a radial rim 435 extending longitudinally along an outer surface 424 of first portion 420. The four bonding boundaries are indicated by a thicker line in FIG. 6. Rims 434 and 435 and the additional bonding boundaries on contact surface 421 and outer surface 424 may additionally or alternatively prevent migration, in both longitudinal and radial directions.

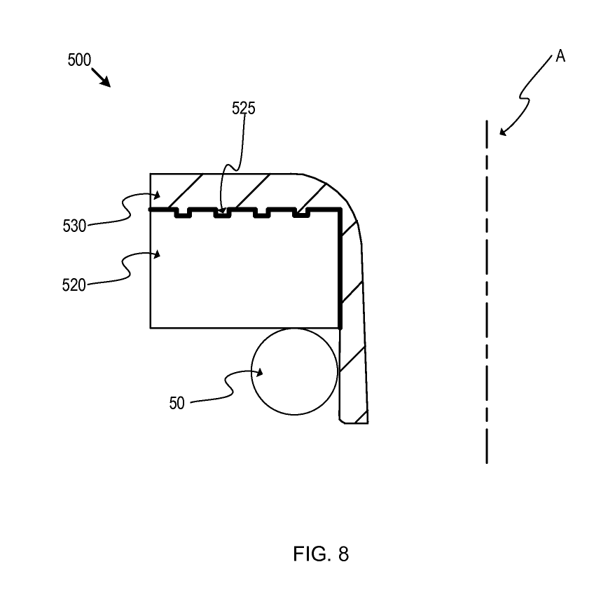

FIG. 8 depicts a cross-sectional view of a section of spring isolator 500 which may have first portion 520 and second portion 530. First portion 520 may have a plurality of surface area-increasing features such as grooves 525 machined into one or more boundaries, including distal boundary 522. Each of grooves 525 may be positioned at a set radius from axis A, extending in a circle, oval, ellipse, or a non-circular path, along the distal boundary. Alternatively, the plurality of grooves 525 may be configured as linear grooves extending radially away from axis A. Grooves 525 may provide additional surface area of bonding between first portion 520 and second portion 530 and may advantageously provide a mechanical impediment to radial migration of first portion 520. The meshed interface between first portion 520 and second portion 530 may advantageously increase the amount of force applied to first portion 520 and second portion 530 necessary to cause second portion 530 to shear off of first portion 520.

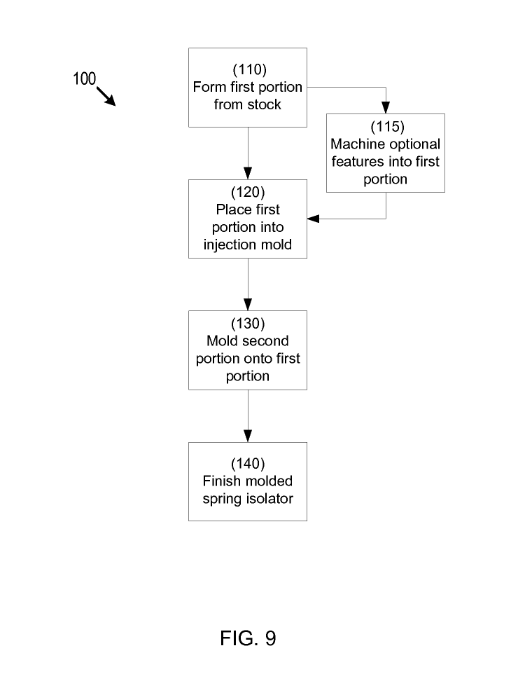

FIG. 9 depicts a flowchart of a method of making a spring isolator, including the various spring isolators depicted in FIGS. 2-8, but specific reference is made to spring isolator 10.

Long tubes of MCU material with a desired cross-sectional profile may be used to create large numbers of first portion 20. For example, the tube-shaped MCU stock may have a cylindrical shape with a constant outer radius, and a constant inner radius defining a longitudinal opening. First portion 20 may be made by cutting the tube-shaped MCU stock into segments of a desired longitudinal thickness (110). For example, first portion 20 may be made by cutting the tube-shaped MCU stock perpendicular to the longitudinal axis.

First portion 20 may be machined to introduce optional surface-area increasing features into one or more surfaces of the first portion 20 (115). This may be accomplished by any number of machining techniques, including, but not limited to, lathing, grinding, milling, drilling, contouring, and laser machining.

First portion 20 may be inserted into a mold of the desired shape of the spring isolator 10 (120). The mold may contain a fixture to hold first portion 20 in a desired position relative to the remaining cavity of the mold. TPU may be injected into the mold, filling the remaining mold cavity (130). The injected TPU may form the second portion 30 in the desired shape of the remaining mold cavity. Where the molten TPU meets one or more surfaces of first portion 20, the TPU and MCU may chemically bond together, forming bonding boundaries. The mold and first portion fixture may be configured so that any desired spring isolator shape and bonding boundaries, including but not limited to the spring isolator shapes depicted in FIGS. 2-8, may be created.

Once the TPU is fully injected and the polymer allowed to cure, the integrated spring isolator 10 may be removed from the mold and finished to remove any imperfections created during the molding process (140).

A substantial cost savings benefit may arise from utilizing segments of tube-shaped MCU stock in making a spring isolator. MCU parts are molded in single-cavity tools because multi-cavity tools for molding MCU are not made. Manufacturers require as many single cavity tools as needed to support mass production volumes, for example, 4 million components per year. By utilizing tube-shaped MCU stock cut into segments, the number of necessary single cavity MCU tools necessary for mass production may be advantageously limited. One advantage is the reduction in costs associated with acquiring and maintaining the additional tooling that may be required to mold MCU.

Thus, spring isolators may be cost-effectively made to desired specifications while exhibiting advantageous abilities to dampen and absorb spring loads and vibrations while resisting migration.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A spring isolator comprising:
a first portion disposed about a longitudinal axis, the first portion comprising a spring contact surface; and
a second portion adjacent to the first portion along at least one boundary, the second portion disposed about the longitudinal axis,
wherein the second portion defines an opening extending along the longitudinal axis, and
wherein the first portion and second portion are chemically bonded together along the at least one boundary.

2. The spring isolator of claim 1, wherein the first portion is a microcellular polyurethane material and the second portion is a thermoplastic polymer material.

3. The spring isolator of claim 2, wherein the second portion is a thermoplastic polyurethane material.

4. The spring isolator of claim 3, wherein the spring isolator is integrally molded onto the first portion.

5. The spring isolator of claim 4, wherein the first portion is chemically bonded to the second portion along a radially inward boundary of the first portion.

6. The spring isolator of claim 4, wherein the first portion is chemically bonded to the second portion along a boundary of the first portion longitudinally distal to the spring contact surface.

7. The spring isolator of claim 4, wherein the first portion is chemically bonded to the second portion along a portion of the spring contact surface.

8. The spring isolator of claim 4, wherein the first portion is chemically bonded to the second portion along a portion of a radially outward surface of the first portion.

9. The spring isolator of claim 4, wherein the first portion is chemically bonded to the second portion along two distinct boundaries.

10. The spring isolator of claim 4, wherein the first portion is chemically bonded to the second portion along three distinct boundaries.

11. The spring isolator of claim 4, wherein the first portion is chemically bonded to the second portion along four distinct boundaries.

12. The spring isolator of claim 1, wherein the second portion further comprises a rim extending radially outward along a section of the contact surface of the first portion.

13. The spring isolator of claim 12, wherein the second portion further comprises a rim extending longitudinally along a section of the radially outward surface of the first portion.

14. The spring isolator of claim 1, wherein the first portion further comprises surface-area increasing features on at least one boundary.

15. A spring isolator comprising:
a first portion disposed about a longitudinal axis, the first portion comprising a spring contact surface, an outer boundary defined by a constant outer radius, and an inner boundary defined by a constant inner radius, wherein the inner boundary defines a first portion opening extending throughout the first portion along the longitudinal axis; and
a second portion integrally molded onto first portion along the inner boundary, the second portion comprising an inner surface defined by a radius less than the constant inner radius of first portion, wherein the inner surface defines a second portion opening extending throughout the second portion along the longitudinal axis,

16. The spring isolator of claim 15, wherein the second portion is integrally molded onto the first portion along a boundary of the first portion longitudinally distal to the spring contact surface.

17. The spring isolator of claim 16, wherein the first portion comprises surface area-increasing features along the boundary longitudinally distal to the spring contact surface.

18. A method of making a spring isolator comprising:
forming a first portion disposed about a longitudinal axis, the first portion comprising a spring contact surface;
inserting the first portion into an injection mold;
injecting thermoplastic polymer material into the injection mold to create a second portion that is chemically bonded without use of any adhesive or external bonding agent to the first portion; and
removing the integrally molded spring isolator from the mold.

19. The method of claim 18, wherein the step of forming the first portion comprises cutting a segment from tube-shaped stock.

20. The method of claim 19,
wherein the tube-shaped stock is microcellular polyurethane material and the tube-shaped stock has a longitudinal axis, and
wherein the first portion is formed by cutting the tube-shaped stock perpendicularly to the longitudinal axis into a tube-shaped segment of a predetermined thickness.

21. The method of claim 20, wherein the thermoplastic polymer material is a thermoplastic polyurethane material.

22. The method of claim 21, further comprising the step of machining surface area-increasing features into at least one surface of the first portion.
